(19) United States
(12) Patent Application Publication
(10) Pub. No.: US 2026/0236825 A1
(43) Pub. Date: Aug. 13, 2026

(54) AGENTIC WORKFLOWS FOR MANAGING AND TESTING SYSTEM REQUIREMENTS

(71) Applicant: NVIDIA Corporation, Santa Clara, CA (US)

(72) Inventors: Aaron J. COHEN, San Jose, CA (US); Yutong YANG, Sunnyvale, CA (US); Samuel Charles VANCE, Provo, UT (US); Jugal BUDDHADEV, Sunnyvale, CA (US); Gregory J. FREEMAN, Austin, TX (US)

(21) Appl. No.: 19/049,944

(22) Filed: Feb. 10, 2025

(51) Int. Cl. G06F 11/22

(52) U.S. Cl. CPC G06N 20/00

(57) ABSTRACT

In various examples, a technique for executing a systems engineering workflow includes matching a user input to graph data associated with an engineered system and determining a context based at least on one or more content items associated with the graph data. The technique also includes generating, via execution of a first machine learning model, an initial version of an additional content item based at least on the context and generating, via execution of a second machine learning model, one or more revisions to the additional content item based at least on one or more critiques associated with the additional content item. The technique further includes causing the engineered system to be updated based at least on the revision(s) to the additional content item.

### TECHNICAL FIELD

Embodiments of the present disclosure relate generally to machine learning and systems engineering, more specifically, to agentic workflows for managing and testing system requirements.

### BACKGROUND

Systems engineering refers to an interdisciplinary approach to designing, integrating, implementing, and managing complex engineered systems across the lifecycles of these engineered systems. Systems engineering processes involve various activities to define, design, manufacture, and deploy an engineered system as a combination of components that work together to achieve a given result and/or achieve a useful function.

For example, systems engineering of an autonomous vehicle or machine may involve several key processes. These processes may include (but are not limited to) requirements engineering that defines, documents, and maintains safety, performance, regulatory, and/or other requirements; developing a system architecture that defines the structure, behavior, and views of sensors, control systems, communications networks, and/or other subsystems in the autonomous vehicle or machine; implementation and integration of software, hardware, structural, mechanical, and/or other components in the autonomous vehicle or machine; testing to evaluate and validate the performance of the autonomous vehicle or machine with respect to various requirements, use cases, and/or scenarios; integrating the components and/or subsystems into a cohesive system; and/or managing and maintaining the operation, use, and/or disposal of the autonomous vehicle or machine across its lifecycle.

Because systems engineering involves developing and updating a large dataset of requirements, test cases, documentation, diagrams, models, evaluations, bug reports, source code, team communications, and/or other content related to an engineered system, it can be difficult to retrieve and/or understand information that is relevant to a given systems engineering task. For example, content generated during a systems engineering workflow may be stored across multiple databases, files, data sources, platforms, and/or formats, which interferes with the efficient location and/or retrieval of a subset of the information that is relevant to the task. Additionally, the information may include acronyms, named entities, terms, jargon, and/or other domain-specific vocabulary that can be confusing and/or difficult to understand.

To improve the retrieval and understanding of data associated with a systems engineering task, a large language model (LLM) may be combined with retrieval-augmented generation (RAG) to generate a response to a prompt (e.g., question, request, etc.) from a user. More specifically, an LLM typically converts an input prompt in the form of text, image data, video data, audio data, and/or other types of data into an abstraction of the content. The LLM uses this abstraction and patterns learned across a vast set of data used to train the LLM to generate a statistically likely response to the prompt. RAG involves converting the input prompt into an embedding in a lower-dimensional latent vector space, using a vector similarity search to match the embedding to additional embeddings of unstructured content items in an available knowledge base, and retrieving a subset of content items with embeddings that are closest to the embedding of the prompt in the latent vector space. The retrieved content is then provided as additional input to the LLM to allow the LLM to generate a more accurate and/or relevant response to the prompt.

However, a conventional RAG approach may fail to retrieve and/or resolve all data that is relevant to a particular prompt. For example, a standard RAG workflow may fail to account for interdependencies and/or relationships across systems engineering requirements and/or components of a system architecture. The standard RAG workflow may also, or instead, fail to resolve the semantic meaning of acronyms, named entities, terms, jargon, and/or other domain-specific vocabulary in the retrieved data. Consequently, the response to a user prompt that is generated using a standard RAG workflow may be incomplete, lack relevance to the prompt, include incorrect formatting and/or structure, and/or include “hallucinations” by the LLM that appear plausible but are incorrect, nonsensical, and/or not in line with the context of the prompt.

As the foregoing illustrates, what is needed in the art are more effective techniques for retrieving and processing information generated during systems engineering workflows.

### BRIEF DESCRIPTION OF THE DRAWINGS

The present systems and methods for customized agentic workflows for managing and testing system requirements are described in detail below with reference to the attached drawing figures, wherein:

FIG. 1 illustrates a block diagram of a computing system configured to implement one or more aspects of at least one embodiment;

FIG. 2 illustrates a system for managing and testing system requirements that includes the orchestration engine and execution engine of FIG. 1, according to at least one embodiment;

FIG. 3 illustrates an example workflow for answering systems engineering questions, according to at least one embodiment;

FIG. 4A illustrates an example workflow for revising a systems engineering requirement, according to at least one embodiment;

FIG. 4B illustrates an example workflow for decomposing a systems engineering requirement, according to at least one embodiment;

FIG. 4C illustrates an example workflow for generating systems engineering requirements, according to at least one embodiment;

FIG. 5A illustrates an example workflow for generating a systems engineering test case, according to at least one embodiment;

FIG. 5B illustrates an example workflow for generating systems engineering test code, according to at least one embodiment;

FIG. 6 is a flow diagram showing a method for executing a systems engineering workflow, according to at least one embodiment;

FIG. 7A is a block diagram of an example generative language model system suitable for use in implementing at least some embodiments of the present disclosure;

FIG. 7B is a block diagram of an example generative language model that includes a transformer encoder-decoder suitable for use in implementing at least some embodiments of the present disclosure;

FIG. 7C is a block diagram of an example generative language model that includes a decoder-only transformer architecture suitable for use in implementing at least some embodiments of the present disclosure;

FIG. 8 is a block diagram of an example computing device suitable for use in implementing at least some embodiments of the present disclosure;

FIG. 9 is a block diagram of an example data center suitable for use in implementing at least some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure; and

FIG. 10D is a system diagram for communication between cloud-based server(s) and the example autonomous vehicle of FIG. 10A, in accordance with some embodiments of the present disclosure.

### DETAILED DESCRIPTION

As discussed herein, systems engineering involves developing and updating a large dataset of requirements, test cases, documentation, diagrams, models, evaluations, bug reports, source code, team communications, and/or other content related to a given engineered system. Consequently, it can be difficult to retrieve and/or understand content that is relevant to a given member of a systems engineering team and/or a systems engineering task. Additionally, the content may include acronyms, named entities, terms, jargon, and/or other domain-specific vocabulary that can be confusing and/or difficult to understand.

To address the above limitations, the disclosed techniques provide a set of customized agentic workflows to streamline various systems engineering tasks. These agentic workflows have access to data from a variety of data sources, including (but not limited to) requirements, models, engineering documents, team communications, databases, knowledge graphs, bug reports, test cases, and/or test results. These agentic workflows may be used to perform tasks such as (but not limited to) question answering; requirement authoring, revision, and/or decomposition; and/or generation and/or refinement of test cases and/or test code.

Each agentic workflow includes one or more large language model (LLMs), vision language models (VLMs), multi-modal language models (MMLMs), large action models (LAMs), and/or other types of machine learning models that are capable of generating predictive output based on inputted text, images, audio data, video data, design data (e.g., computer aided design (CAD) data, universal scene descriptor (USD) data—such as OpenUSD data, etc.) and/or other types of data. The machine learning model(s) may implement agents that act as mappers, researchers, drafters, critics, revisers, linters, and/or other roles in systems engineering processes. Each agent performs a corresponding set of one or more tasks based on a system prompt that describes a corresponding role, a user prompt that includes information and/or instructions that can be used to perform the task(s), and/or one or more example inputs and/or outputs associated with the task(s). Output generated by the agent may be provided to another agent in the same agentic workflow and/or a user, and a final output of the agentic workflow may be generated via iterative execution of some or all agents in the agentic workflow based on critiques of the output by one or more agents and/or feedback from the user.

One technical advantage of the disclosed techniques relative to prior approaches is the ability to efficiently access, search, retrieve, and/or define information that is relevant to a given systems engineering task. Consequently, the disclosed techniques reduce latency and/or resource overhead over conventional approaches that involve manually locating and retrieving information that is relevant to a systems engineering task and/or resolving acronyms, named entities, terms, jargon, and/or other domain-specific vocabulary related to the systems engineering task. Another technical advantage of the disclosed techniques is the ability to adapt and/or customize the agents and/or stages within a given agentic workflow to the dependencies, data formats, and/or structure of a corresponding systems engineering task. The disclosed techniques can thus improve the quality of output generated by the agentic workflows over conventional approaches that use LLMs with RAG to generate responses to user prompts.

The above examples are not in any way intended to be limiting. As persons skilled in the art will appreciate, as a general matter, the techniques for automatically generating dialogue flows from unlabeled conversation data can be implemented in any suitable application.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as LLMs/VLMs/multi-modal language models/other model types that may process text, audio, 3D data, and/or image data, systems for performing light transport simulation, systems for performing collaborative content creation for 3D assets, systems implemented at least partially using cloud computing resources, systems for performing generative AI operations, and/or other types of systems.

### System Overview

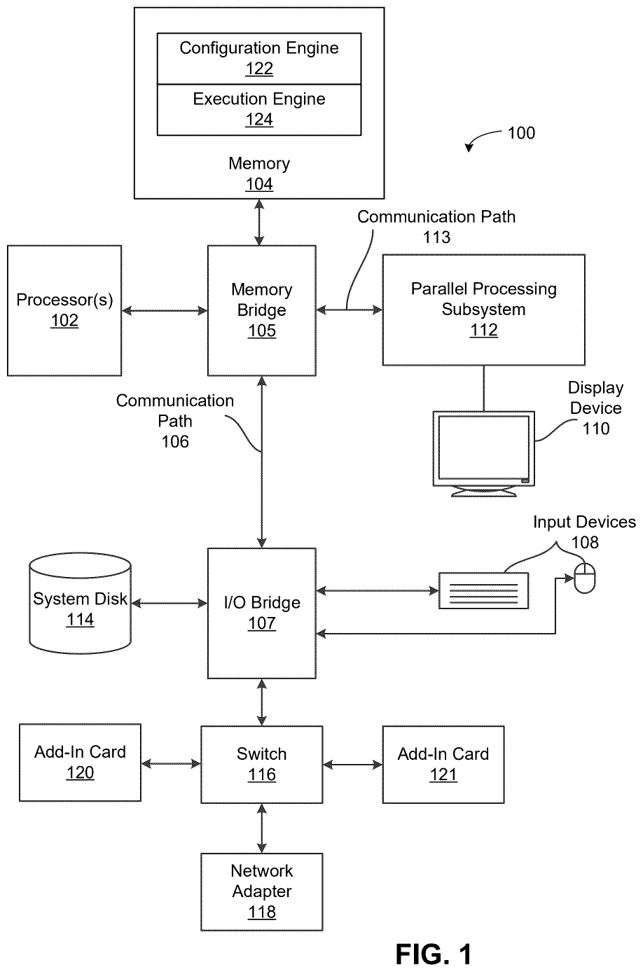

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network. In one or more embodiments, computing system 100 is included in and/or accessible to a robot, autonomous vehicle, semi-autonomous vehicle, and/or another type of machine that is capable of performing perception, planning, control, prediction, and/or other tasks related to moving and/or navigating within large, dynamic, and/or semi-structured environments.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include an orchestration engine 122 and an execution engine 124, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Agentic Workflows for Managing and Testing System Requirements

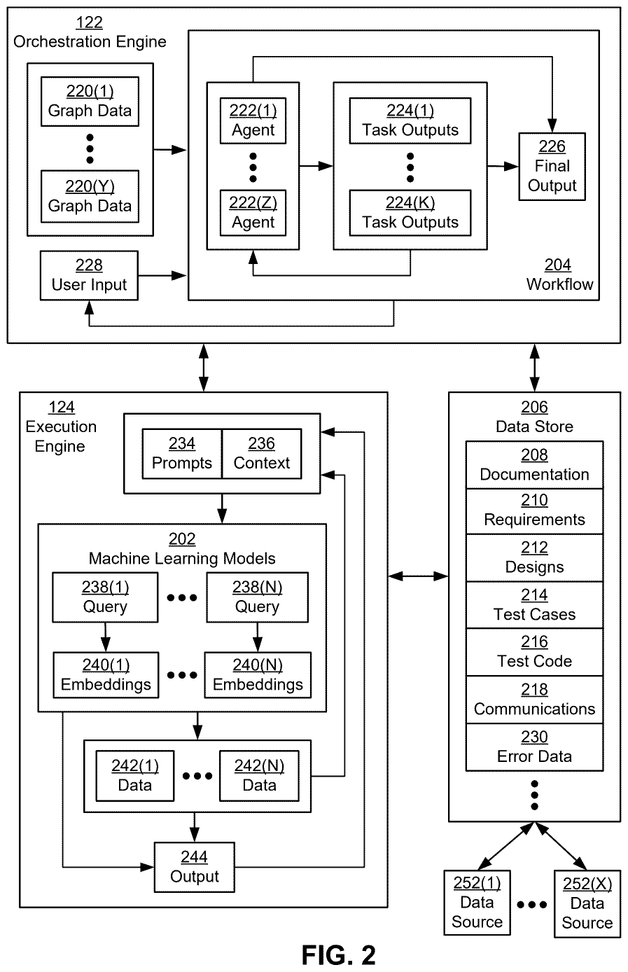

FIG. 2 illustrates a system for managing and testing system requirements that includes orchestration engine 122 and execution engine 124 of FIG. 1, according to at least one embodiment. In some embodiments, orchestration engine 122 and execution engine 124 include functionality to provide agentic workflows for managing and testing system requirements. Each of these components is described in further detail below.

Orchestration engine 122 configures and/or manages the execution of a systems engineering workflow 204 that is carried out by a set of agents 222(1)-222(Z) (each of which is referred to individually herein as agent 222) on behalf of one or more users. For example, orchestration engine 122 may include functionality to generate and/or execute one or more agents 222 that streamline and/or automate at least a portion of a given workflow 204 for answering systems engineering questions; authoring, revising, and/or decomposing systems engineering requirements 210; and/or generating or refining test cases 214 and/or test code 216.

Each agent 222 may include a set of components and/or modules that are capable of reasoning, planning, making decisions, and/or taking actions to solve problems in an autonomous manner. For example, each agent 222 may be implemented using one or more machine learning models 202 that generate one or more task outputs 224(1)-224(K) (each of which is referred to individually herein as task outputs 224) related to a corresponding task. Task outputs 224 generated by one agent 222 may be iteratively updated by that agent 222 and/or inputted into another agent 222 to assist in the generation of additional task outputs 224 by the other agent.

In some embodiments, each agent 222 generates one or more corresponding task outputs 224 by accessing, generating, and/or modifying data in a data store 206. For example, data store 206 may include a relational database, vector database, graph database, key-value store, data warehouse, filesystem, and/or another type of repository for data associated with a systems engineering project.

Data store 206 may include data from a variety of data sources 252(1)-252(X) (each of which is referred to individually herein as data source 252). For example, data store 206 may be used to aggregate, mirror, and/or otherwise store representations of data from a requirements management system, code repository, document repository, design repository, knowledge base, filesystem, email system, chat system, bug tracking system, and/or another type of data source 252.

As shown in FIG. 2, data associated with and/or included in data store 206 may include (but is not limited to) documentation 208, requirements 210, designs 212, test cases 214, test code 216, communications 218, and/or error data 230 associated with an engineered system. The engineered system may include, hardware, software, mechanical components, electrical components, organic components, power sources, and/or other types of components that interact with one another to form a structure, set of functions, and/or set of behavior.

Documentation 208 includes definitions, instructions, guidelines, and/or other information related to the design, integration, and/or management of the engineered system. For example, documentation 208 may include (but are not limited to) systems engineering definitions (e.g., International Council on Systems Engineering (INCOSE) system and systems engineering definitions); standards and/or regulations associated with the engineered system; task definitions that specify goals, problems, objectives, and/or tasks related to the engineered system; project plans, schedules, risk management plans, progress reports, and/or other types of project management documentation; instructions for operating and/or maintaining the engineered system; engineering and/or design documents; and/or version control records, change logs, and/or other records of changes to the configuration of the engineered system over time.

Requirements 210 include conditions to be satisfied by the engineered system, components of the engineered system, workflows related to the engineered system, and/or processes associated with development of the engineered system. For example, requirements 210 associated with an engineered system that includes a robot, vehicle, construction machine, warehouse vehicle/machine, autonomous vehicle, semi-autonomous vehicle, and/or other machine type may include identifiers, names, descriptions, and/or context related to hardware components, software components, operation, safety, functional performance, and/or reliability of the machine.

Designs 212 include plans, drawings, diagrams, and/or other conceptual representations of the engineered system and/or components within the engineered system. For example, designs 212 may include (but are not limited to) architectural designs, interface designs, functional designs, physical designs, behavioral designs, and/or data designs related to the engineered system.

Test cases 214 include parameters and/or scenarios that can be used to verify that the engineered system meets requirements 210. For example, a given test case may include an identifier, objective, preconditions, inputs, execution steps, expected results, postconditions, and/or pass/fail criteria associated with a corresponding requirement.

Test code 216 includes code-based implementations of test cases 214. For example, test code 216 for a given test case may be used to set up a test scenario, implement steps in the test case, and/or evaluate the results of the test case.

Communications 218 may include discussions related to the engineered system. For example, communications 218 may include (but are not limited to) emails, chat messages, meeting transcripts and/or summaries, memos, and/or other records of interactions within and/or across teams involved in defining, designing, developing, and/or manufacturing the engineered system.

Error data 230 includes information related to bugs, defects, vulnerabilities, anomalies, faults, failures, exceptions, crashes, incidents, and/or other issues with the design and/or operation of the engineered system. For example, error data 230 may include (but is not limited to) bug reports, severity and/or priority levels, environment details, system logs, error messages, stack traces, sensors data, test case results, tracking data, and/or other data that can be used to identify, track, organize, prioritize, and/or resolve these issues.

In one or more embodiments, orchestration engine 122 sets up workflow 204 based on one or more sets of graph data 220(1)-220(Y) (each of which is referred to individually herein as graph data 220). Graph data 220 may be retrieved from data store 206 and/or one or more data sources 252. Each set of graph data 220 may include a directed acyclic graph (DAG) of nodes and edges that represent components and/or relationships associated with the engineered system, a portion of the engineered system, and/or a systems engineering workflow 204. Each set of graph data 220 may include and/or be associated with documentation 208, requirements 10, designs 212, test cases 214, test code 216, communications 218, error data 230, and/or other types of data in data store 206.

In some embodiments, graph data 220 includes a decomposition of the engineered system into components and dependencies. For example, graph data 220 associated with an engineered system that includes a robot, vehicle, construction machine, warehouse vehicle/machine, autonomous vehicle, semi-autonomous vehicle, and/or other machine type may include nodes that represent a set of sensors, environment mapping system, localization system, perception system, egomotion system, motion planning system, control system, and/or actuation system. This graph data 220 may also include edges between pairs of nodes that represent relationships, interactions, and/or dependencies between the corresponding components (e.g., an edge from a first node representing a motion planning system to a second node representing a control system represents the transmission of a trajectory from the motion planning system to the control system, an edge from the second node to a third node representing an actuation system represents the transmission of an acceleration from the control system to the actuation system, etc.).

Graph data 220 also, or instead, includes a representation of a given systems engineering workflow 204 to be configured and/or executed via orchestration engine 122. For example, graph data 220 associated with a certain workflow 204 may include nodes that represent stages and/or steps within that workflow 204, components implemented by agents 222 within that workflow 204, and/or other portions of that workflow 204. This graph data 220 may also include edges between pairs of nodes that represent dependencies, interactions, and/or relationships between the corresponding portions of that workflow 204 (e.g., the output of one portion of workflow 204 is provided as input into another portion of workflow 204).

Graph data 220 also, or instead, includes other types of information arranged into nodes and edges. For example, graph data 220 may include (but is not limited to) requirement traceability graph, knowledge graphs, data flow architecture graphs, and/or other types of graphs that model entities and/or relationships associated with systems engineering and/or a given engineered system.

Orchestration engine 122 additionally configures and/or executes workflow 204 based on user input 228 provided by a user involved in designing, testing, and/or managing the engineered system. User input 228 may specify the engineered system, a portion of the engineered system, a specific workflow 204 to be executed, and/or another subset of a systems engineering project; one or more tasks to be accomplished via workflow 204; preferences, guidelines, and/or rules used to carry out the task(s) and/or workflow 204; data to be used to carry out workflow 204; and/or other information and/or context related to workflow 204.

In some embodiments, user input 228 includes data that is specific to the type of workflow 204 to be performed. For example, user input 228 may include a name, identifier, command, request, and/or another indication of a specific workflow 204 to be performed (e.g., answering systems engineering questions; authoring, revising, and/or decomposing systems engineering requirements 210; generating or refining test cases 214 and/or test code 216; etc.). After this user input 228 is matched to a corresponding workflow 204, orchestration engine 122 may request additional user input 228 that is used to configure the execution of one or more agents 222 within that workflow 204. Task outputs 224 generated by each agent 222 may also be provided to the user, and additional user input 228 from the user may be used to refine and/or guide the generation of subsequent task outputs 224 by the same agent 222 and/or other agents 222. Thus, task outputs 224 may be generated, updated, and/or refined by agents 222 and/or based on user input 228 until a final output 226 that accomplishes the task(s) specified in user input 228 is generated.

Execution engine 124 executes each agent 222 to generate output 244 related to a corresponding task or set of tasks. As shown in FIG. 2, execution engine 124 inputs one or more prompts 234 and/or context 236 associated with a given task into one or more machine learning models 202 implementing a given agent 222. For example, execution engine 124 may input prompts 234 and/or context 236 in the form of text, images, audio, video, documents, data structures, design data, 3D collaborative content data (e.g., USD data, such as OpenUSD data), and/or other types of data into a large language model (LLM), vision language model (VLM), multi-modal language model (MMLM), embedding model, classification model, regression model, and/or another type of machine learning model that is capable of processing and/or generating the same types of data.

In some embodiments, execution engine 124 uses machine learning models 202 to generate one or more queries 238(1)-238(N) (each of which is referred to individually herein as query 238) of data store 206. Execution engine 124 also, or instead, uses machine learning models 202 to convert each query 238 into one or more corresponding embeddings 240(1)-240(N) (each of which is referred to individually as embedding 240).

Execution engine 124 uses queries 238 and/or embeddings 240 to retrieve one or more sets of data 242(1)-242(N) (each of which is referred to individually as data 242) associated with the task from data store 206. Execution engine 124 uses machine learning models 202 to generate output 244 related to the task based on the retrieved data 242. Execution engine 124 further updates prompts 234 and/or context 236 based on the retrieved data 242, output 244, and/or user input 228 related to output 244. Execution engine 124 additionally uses the same machine learning models 202 and/or different machine learning models 202 to generate additional queries 238, embeddings 240, data 242, and/or output 244 based on the updated prompts 234 and/or context 236. Consequently, execution engine 124 may use one or more machine learning models 202 to iteratively generate, update, and/or refine output 244 related to a corresponding task until output 244 can be included in one or more task outputs 224 associated with completion of the task.

In one or more embodiments, a given agent 222 invokes one or more tools to perform a corresponding task or set of tasks. For example, a given agent 222 may call a code module corresponding to a tool to perform a database lookup, generate queries 238, generate embeddings 240, and/or generate and/or retrieve other types of data associated with the task(s).

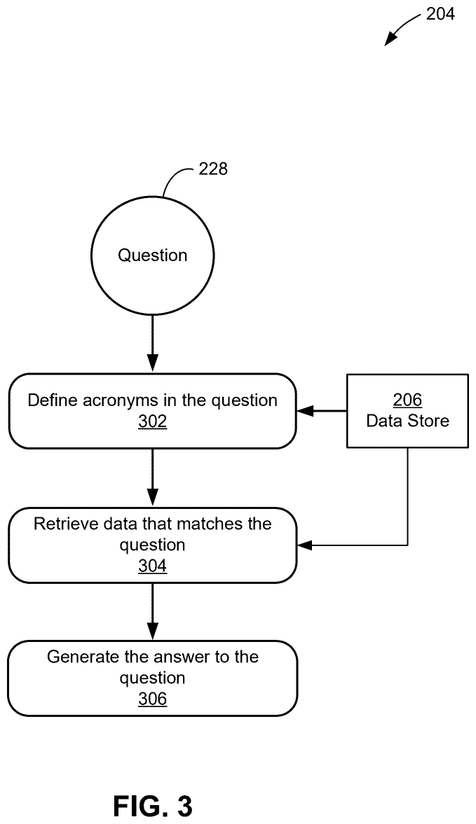

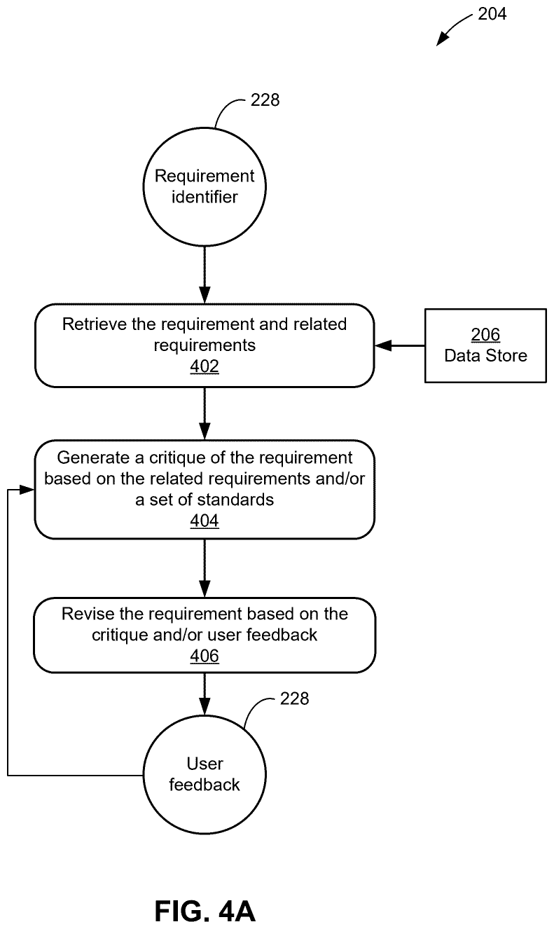

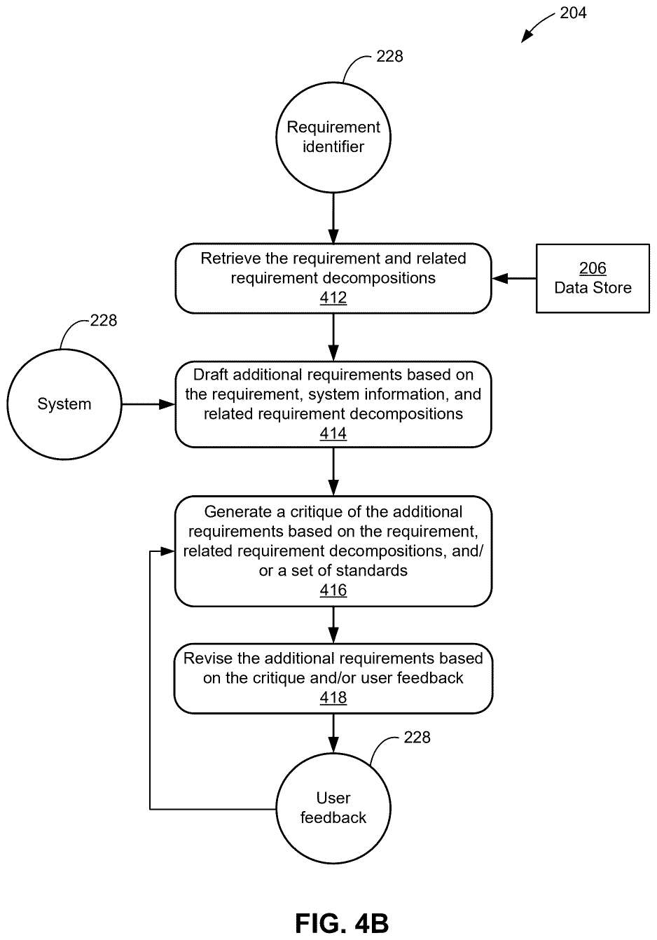

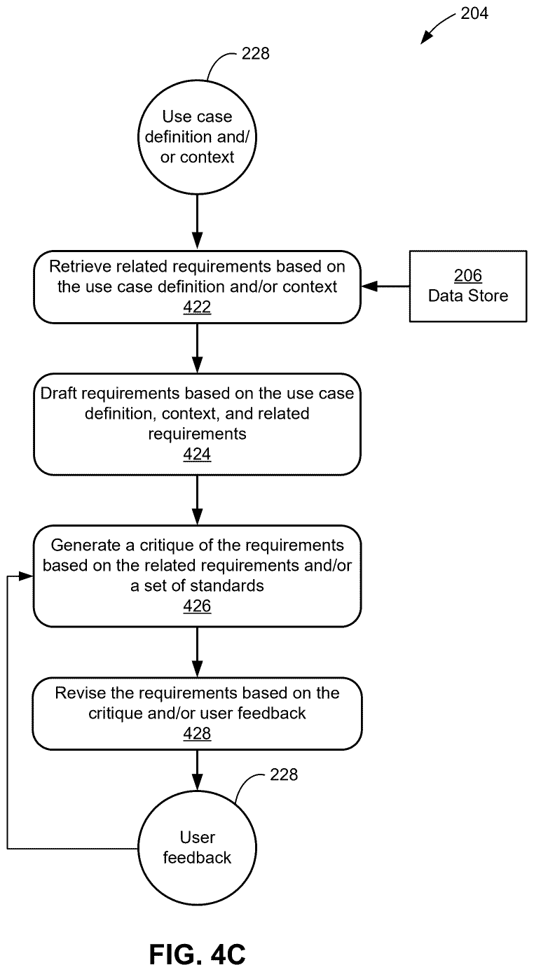

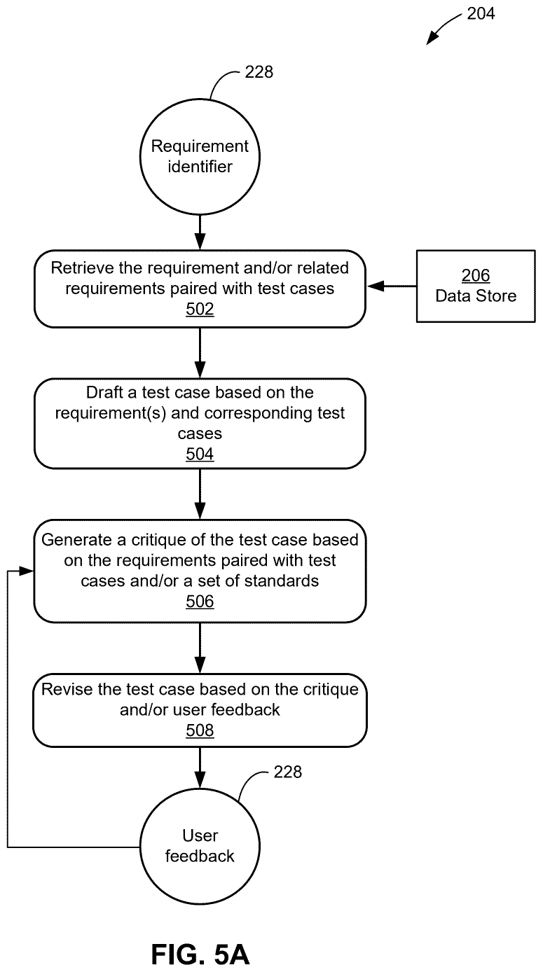

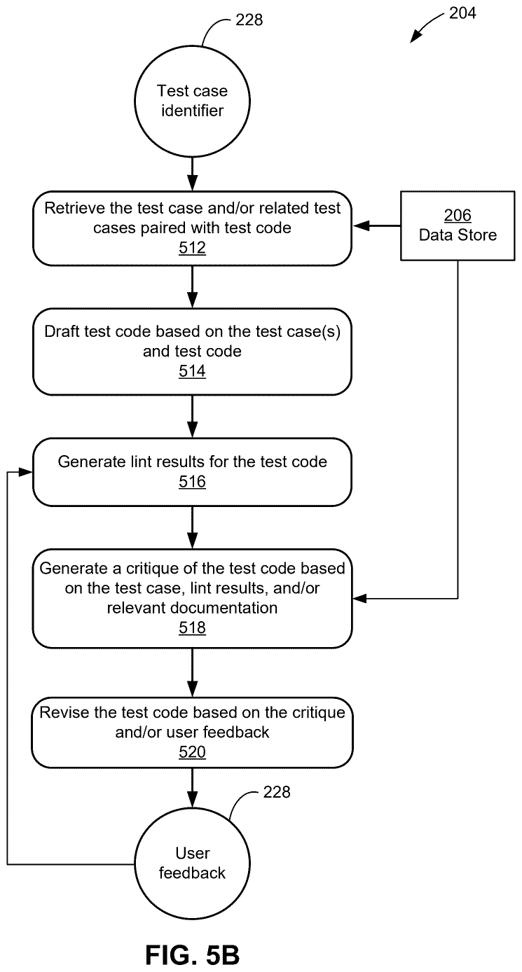

As discussed herein, orchestration engine 122 and execution engine 124 include functionality to execute various types of systems engineering workflows. These workflows may include a question-and-answer workflow 204 that generates answers to systems engineering questions, which is described in further detail herein with respect to FIG. 3. These workflows may also, or instead, include one or more workflows related to authoring, revising, and/or decomposing systems engineering requirements 210, which are described in further detail below with respect to FIGS. 4A-4C. These workflows may also, or instead, include one or more workflows related to generating or refining test cases 214 and/or test code 216, which are described in further detail below with respect to FIGS. 5A-5B.

FIG. 3 illustrates an example workflow 204 for answering systems engineering questions, according to at least one embodiment. As shown in FIG. 3, the example workflow 204 begins with receiving user input 228 in the form of a question. For example, the question may be received via a chat interface and/or another type of user interface. The question may be related to documentation 208, requirements 210, designs 212, test cases 214, test code 216, communications 218, error data 230, and/or other data related to an engineered system. The question may be provided in the form of a prompt and/or another type of input to workflow 204.

One or more agents 222 executing workflow 204 process the question by performing a step 302 of defining acronyms in the question. For example, the agent(s) 222 may include LLMs, VLMs, MMLMs, and/or other types of machine learning models 202 that are prompted, fine-tuned, and/or trained to extract acronyms from the question. The agent(s) 222 may also, or instead, use named entity recognition, natural language processing, and/or other techniques to identify acronyms in the question. After acronyms are identified in the question, the agent(s) 222 may resolve the acronyms by performing a lookup of the acronyms in a dictionary, database, and/or another data store 206.

Next, the agent(s) 222 perform a step 304 of retrieving data that matches the question. For example, the agent(s) 222 may retrieve documentation 208, requirements 210, designs 212, test cases 214, test code 216, communications 218, error data 230, and/or other data that matches one or more identifiers in the question from data store 206. The agent(s) 222 may also, or instead, perform a vector and/or semantic search of data store 206 using the question, named entities in the question, queries 238 generated from the question, and/or embeddings 240 of the question, named entities, and/or queries 238.

The agent(s) 222 then perform a step 306 of generating the answer to the question. For example, the agent(s) 222 may include one or more LLMs, VLMs, MMLMs, and/or other types of machine learning models 202 that are prompted, fine-tuned, and/or trained to generate the answer, given context that includes data retrieved in step 304, summaries of the data, and/or other representations of the data. After the answer is generated, the answer may be returned as a response to the question. For example, the answer may be outputted in a chat interface and/or another type of user interface from which the question was received.

The operation of the example workflow 204 of FIG. 3 may be illustrated with a question of “What are the boot times for CAS?” Given this question, step 302 may be used to identify “CAS” as an acronym and retrieve a corresponding definition of “collision avoidance system.” Next, step 304 may be used to perform a lookup of records in data store 206 that match “CAS,” “collision avoidance system,” and/or “boot time.” Step 306 may then be performed using one or more retrieved records to generate an answer of “Boot times for CAS range from 15 milliseconds to 1.6 seconds.”

FIG. 4A illustrates an example workflow 204 for revising a systems engineering requirement, according to at least one embodiment. As shown in FIG. 4A, the example workflow 204 begins with receiving user input 228 in the form of a requirement identifier. For example, the requirement identifier may be specified by a user via a chat interface and/or another type of user interface.

One or more agents 222 executing workflow 204 process user input 228 by performing a step 402 of retrieving the requirement and a set of related requirements. For example, step 402 may be performed by a “researcher” node that matches the requirement identifier to a corresponding requirement in data store 206. The researcher node may also use graph data 220 that models relationships between requirements to identify the related requirements (e.g., as requirements that share the same parent requirement as the requirement, requirements that are connected to the requirement via one or more edges, etc.). The researcher node may also, or instead, identify the related requirements based on semantic similarity to the requirement (e.g., using semantic search, RAG, and/or other techniques). The researcher node may additionally retrieve the requirements from data store 206 (e.g., using identifiers for the requirements from graph data 220 and/or search results).

Next, the agent(s) 222 perform a step 404 of generating a critique of the requirement based on the related requirements and/or a set of standards. For example, step 404 may be performed by a “critic” node that is implemented using one or more LLMs, VLMs, MMLMs, and/or other types of machine learning models 202. Input into these machine learning models 202 may include one or more prompts 234 that specify a role of the critic node (e.g., “You are a world-class critic for engineered system requirements”), a task to be performed by the critic node (e.g., “You will be given a system requirement and must provide helpful criticism”), criteria related to the task (e.g., standards for clarity, specificity, measurability, consistency, completeness, logical correctness, formatting, etc.), and/or instructions for performing the task (e.g., “Do not include critiques for example requirements,” “Do not generate new requirements or suggested revisions,” etc.). Input into these machine learning models 202 may also, or instead, include the requirement that matches the requirement identifier and one or more related requirements. Given this input, the critic node may generate a critique that rates and/or assesses the degree to which the requirement meets the specified criteria.

The agent(s) 222 then perform a step 406 of revising the requirement based on the critique. For example, step 406 may be performed by a “reviser” node that is implemented using one or more LLMs, VLMs, MMLMs, and/or other types of machine learning models 202. Input into these machine learning models 202 may include one or more prompts 234 that specify a task to be performed by the reviser node (e.g., “You will be given one or more requirements that you must revise, and may also be given relevant information related to similar features or requirements”), instructions for performing the task (e.g., formatting of the drafted requirements, specifications for requirement semantics, rules for drafting the requirements, etc.), and/or other information related to the task. Input into these machine learning models 202 may also, or instead, include the requirement, critique, and/or related requirement(s). Given this input, the reviser node may generate a revised requirement based on the inputted information.

The agent(s) 222 receive additional user input 228 in the form of user feedback related to the revised requirement. For example, the agent(s) 222 may output the revised requirement generated in step 406 to the user in a chat interface and/or another type of user interface from which the requirement identifier was received. The user may review the revised requirement and provide the user feedback via the same user interface.

The agent(s) 222 may additionally repeat steps 404 and/or 406 one or more times to further revise the requirement based on additional critiques and/or user feedback. For example, the agent(s) 222 may iteratively generate a new critique of a revised requirement, receive user feedback related to a revised requirement, and/or make additional revisions to the requirement until the user is satisfied with the revised requirement, the critique indicates that the requirement meets the specified criteria, and/or another condition is met.

The operation of the example workflow 204 of FIG. 4A may be illustrated with a requirement related to lane change procedures in an autonomous vehicle. The critic node may generate a critique that includes the following:
Clarity and Specificity: Needs improvement for better readability and to remove ambiguity.
Measurability: Satisfactory.
Consistency: Satisfactory.
Completeness: Needs improvement to cover more scenarios.
Logical: Satisfactory but could be more precise.
Overall, the requirement is functional but could benefit from revisions to improve clarity, completeness, and specificity.

Based on the critique, the reviser node may generate the following revised requirement:
Revised Requirement Name: Cancel Lane Change if Lane Marking Is Not Visible
Revised Requirement Description: While conducting the Lane Change procedure, if the forward lane marking of the target lane is neither visible nor legally allowable, the Lane Change shall be interrupted with an interruption trajectory to the original lane before the Point of No Return. After the Point of No Return, the Lane Change shall be executed as originally planned.
Revised Requirement Context: Lane change abortion location should be further considered from a safety point of view to see returning to the original starting lane is allowed after part of the vehicle has crossed the lane marking. The lane marking range is determined by stop distance, and lane markings can be detected from mapping and/or perception path. If lane markings are not available from both mapping and perception paths, the lane change will be cancelled.

FIG. 4B illustrates an example workflow 204 for decomposing a systems engineering requirement, according to at least one embodiment. As shown in FIG. 4B, the example workflow 204 begins with receiving user input 228 in the form of a requirement identifier and a system. For example, the requirement identifier and system may be specified by a user via a chat interface and/or another type of user interface.

One or more agents 222 executing workflow 204 perform a step 412 of retrieving a requirement and related requirement decompositions based on the requirement identifier. For example, step 412 may be performed by a “researcher” node that matches the requirement identifier to a corresponding requirement in data store 206. The researcher node may also use graph data 220 that models relationships between requirements to identify one or more related requirements (e.g., as requirements that share the same parent requirement as the requirement, requirements that are connected to the requirement via one or more edges, etc.). The researcher node may also, or instead, retrieve the related requirements based on semantic similarity to the requirement. The researcher node may retrieve the requirements from data store 206 (e.g., using identifiers for the requirements in graph data 220 and/or search results of a semantic search associated with the requirement). The researcher node may additionally use graph data 220 to identify and retrieve, for each related requirement, a set of additional requirements into which the related requirement is decomposed (e.g., using edges between a node representing the related requirement and a set of child nodes representing the additional requirements). The researcher node may further generate a related requirement decomposition that includes the related requirement and additional requirements.

Next, the agent(s) 222 perform a step 414 of drafting additional requirements based on the requirement, system information, and related requirement decompositions. For example, step 414 may be performed by a “drafter” node that is implemented using one or more LLMs, VLMs, MMLMs, and/or other types of machine learning models 202. Input into these machine learning models 202 may include one or more prompts 234 that specify a task to be performed by the drafter node (e.g., “You will be provided with a requirement that either has no children, or lacks children corresponding to a desired component. You will also be provided with example decompositions to help you understand how to decompose a requirement. You will decompose a given requirement into requirements for {system}.”), instructions for performing the task (e.g., formatting of the drafted requirements, specifications for requirement semantics, rules for drafting the requirements, etc.), and/or other information related to the task. Input into these machine learning models 202 may also, or instead, include the requirement, system information associated with the system, and example requirement decompositions. Given this input, the drafter node may output one or more additional requirements that correspond to a decomposition of the requirement into lower-level requirements.

The agent(s) 222 then perform a step 416 of generating a critique of the additional requirements based on the requirement, related requirement decompositions, and/or a set of standards. For example, step 416 may be performed by a “critic” node that is implemented using one or more LLMs, VLMs, MMLMs, and/or other types of machine learning models 202. Input into these machine learning models 202 may include one or more prompts 234 that specify a role of the critic node (e.g., “You are a world-class critic for engineered system requirement decompositions”), a task to be performed by the critic node (e.g., “You will be given a system requirement decomposition and must provide helpful criticism”), criteria related to the task (e.g., standards for clarity, specificity, measurability, consistency, completeness, logical correctness, formatting, relevance of the additional requirements to the system, relevance of the additional requirements to the requirement, etc.), and/or instructions for performing the task (e.g., “Do not include critiques for example requirement decompositions,” “Do not generate new requirements, requirement decompositions, or suggested revisions,” etc.). Input into these machine learning models 202 may also, or instead, include the requirement, additional requirements, example requirement decompositions, and/or standards. Given this input, the critic node may generate a critique that rates and/or assesses the degree to which each additional requirement meets the specified criteria. The critique may also, or instead, identify redundant additional requirements to be removed and/or merged.

The agent(s) 222 perform a step 418 of revising the additional requirements based on the critique. For example, step 418 may be performed by a “reviser” node that is implemented using one or more LLMs, VLMs, MMLMs, and/or other types of machine learning models 202. Input into these machine learning models 202 may include one or more prompts 234 that specify a task to be performed by the reviser node (e.g., “You will be given one or more requirements that you must revise, and may also be given relevant information related to similar features or requirements”), instructions for performing the task (e.g., formatting of the drafted requirements, specifications for requirement semantics, rules for drafting the requirements, guidelines for relating the requirements to the system, etc.), and/or other information related to the task. Input into these machine learning models 202 may also, or instead, include the additional requirements and the critique. Given this input, the reviser node may generate revisions to the additional requirements.

The agent(s) 222 receive additional user input 228 in the form of user feedback related to the revised requirements. For example, the agent(s) 222 may output the revised requirements generated in step 418 to the user in a chat interface and/or another type of user interface from which the initial input was received. The user may review the revised requirements and provide feedback via the same user interface.

The agent(s) 222 may additionally repeat steps 416 and/or 418 one or more times to further revise the requirements based on additional critiques and/or user feedback. For example, the agent(s) 222 may iteratively revise the requirements until the user is satisfied with the decomposed requirements, the critique indicates that the requirements meet the specified criteria, and/or another condition is met.

The operation of the example workflow 204 of FIG. 4B may be illustrated with a requirement related to following traffic signs and a system that includes an autonomous vehicle. The drafter node may generate a decomposition of the requirement into the following additional requirement:
Requirement Name: No Turn on Red Arrow
Requirement Description: While the red arrow traffic signal is active, the system shall prevent the vehicle from making a turn in the direction indicated by the red arrow.

The critic node may generate a critique that includes the following:
Clarity and Specificity: The requirement is clear and specific, detailing the prohibition of turning on a red arrow.
Measurability: The requirement is measurable as it specifies the condition (red arrow) and the action (prevent turn).
Consistency: The requirement is consistent with typical traffic rules and should align the other traffic sign-related requirements.
Completeness: The requirement addresses the scenario of encountering a red arrow but does not specify what happens after the red arrow is no longer active.
Logical: The requirement is logically correct.
Boilerplate Text: No boilerplate text is present.

Based on the critique, the reviser node may generate the following revised requirement:
Revised Requirement Name: No Turn on Red Arrow
Revised Requirement Description: While the red arrow traffic signal is active, the Vehicle shall prevent any turn in the direction indicated by the red arrow.

FIG. 4C illustrates an example workflow 204 for generating systems engineering requirements, according to at least one embodiment. As shown in FIG. 4C, the example workflow 204 begins with receiving user input 228 in the form of a use case definition and/or context. For example, the use case definition may be specified by a user via a chat interface and/or another type of user interface. The use case definition may describe a use case for an engineered system, and the context may include additional information related to the use case. For example, a use case definition associated with an autonomous vehicle may include a driver's handbook of rules, laws, and/or guidelines for driving in a given location. The context may include user-specified instructions, parameters, guidelines, and/or other information related to one or more requirements to be generated from the use case definition.

One or more agents 222 executing workflow 204 perform a step 422 of retrieving related requirements based on the use case definition and/or context. For example, step 422 may be performed by a “researcher” node that identifies related requirements in data store 206 based on semantic similarity to the use case definition and/or context.

Next, the agent(s) 222 perform a step 424 of drafting requirements based on the use case definition, context, and related requirements. For example, step 424 may be performed by a “drafter” node that is implemented using one or more LLMs, VLMs, MMLMs, and/or other types of machine learning models 202. Input into these machine learning models 202 may include one or more prompts 234 that specify a task to be performed by the drafter node (e.g., “You will be provided with a requirement or a use case specification that needs to be formalized into one or more requirements. You may also be provided with example requirements that pertain to similar use cases or features. You will decide how many individual requirements to be generated.”), instructions for performing the task (e.g., formatting of the drafted requirements, specifications for requirement semantics, rules for drafting the requirements from the use case definition and/or context, etc.), and/or other information related to the task. Input into these machine learning models 202 may also, or instead, include the use case definition, context, and/or related requirements. Given this input, the drafter node may output one or more requirements associated with the use case definition and/or context.

The agent(s) 222 then perform a step 426 of generating a critique of the requirements based on the related requirements and/or a set of standards. For example, step 426 may be performed by a “critic” node that is implemented using one or more LLMs, VLMs, MMLMs, and/or other types of machine learning models 202. Input into these machine learning models 202 may include one or more prompts 234 that specify a role of the critic node (e.g., “You are a world-class critic for engineered system requirements”), a task to be performed by the critic node (e.g., “You will be given a system requirement and must provide helpful criticism”), criteria related to the task (e.g., standards for clarity, specificity, measurability, consistency, completeness, logical correctness, formatting, relevance to the use case definition, relevance to the context, etc.), and/or instructions for performing the task (e.g., “Do not include critiques for example requirements,” “Do not generate new requirements or suggested revisions,” etc.). Input into these machine learning models 202 may also, or instead, include the drafted requirements, related requirements, use case definition, and/or context. Given this input, the critic node may generate a critique that rates and/or assesses the degree to which each requirement meets the specified criteria.

The agent(s) 222 perform a step 428 of revising the requirements based on the critique. For example, step 428 may be performed by a “reviser” node that is implemented using one or more LLMs, VLMs, MMLMs, and/or other types of machine learning models 202. Input into these machine learning models 202 may include one or more prompts 234 that specify a task to be performed by the reviser node (e.g., “You will be given one or more requirements that you must revise, and may also be given relevant information related to similar features or requirements”), instructions for performing the task (e.g., formatting of the drafted requirements, specifications for requirement semantics, rules for drafting the requirements, etc.), and/or other information related to the task. Input into these machine learning models 202 may also, or instead, include the drafted requirements and the critique. Given this input, the reviser node may generate revisions to the drafted requirements.

The agent(s) 222 receive additional user input 228 in the form of user feedback related to the revised requirements. For example, the agent(s) 222 may output the revised requirements generated in step 428 to the user in a chat interface and/or another type of user interface from which the initial input was received. The user may review the revised requirements and provide feedback via the same user interface.

The agent(s) 222 may additionally repeat steps 426 and/or 428 one or more times to further revise the requirements based on additional critiques and/or user feedback. For example, the agent(s) 222 may iteratively revise the requirements until the user is satisfied with the generated requirements, the critique indicates that the requirements meet the specified criteria, and/or another condition is met.

FIG. 5A illustrates an example workflow 204 for generating a systems engineering test case, according to at least one embodiment. As shown in FIG. 5A, the example workflow 204 begins with receiving user input 228 in the form of a requirement identifier. For example, the requirement identifier may be specified by a user via a chat interface and/or another type of user interface.

One or more agents 222 executing workflow 204 process user input 228 by performing a step 502 of retrieving the requirement and/or related requirements paired with test cases. For example, step 502 may be performed by a “researcher” node that matches the requirement identifier to a corresponding requirement and/or set of test cases in data store 206. The researcher node may also use graph data 220 associated with the requirement to identify one or more related requirements. The researcher node may also, or instead, identify the related requirements based on semantic similarity to the requirement (e.g., as determined using cosine similarities between an embedding of the requirement and embeddings of other requirements). The researcher node may additionally retrieve the requirements and associated test cases from data store 206 (e.g., using identifiers for the requirements in graph data 220 and/or search results of a semantic search associated with the requirement). When the requirement identifier cannot be matched to a corresponding requirement in data store 206, the researcher node may search for similar requirements and corresponding test cases based on semantic similarity to the requirement identifier and/or other information in the provided user input 228.

Next, the agent(s) 222 perform a step 504 of drafting a test case based on the requirement(s) and corresponding test cases. For example, step 504 may be performed by a “drafter” node that is implemented using one or more LLMs, VLMs, MMLMs, and/or other types of machine learning models 202. Input into these machine learning models 202 may include one or more prompts 234 that specify a task to be performed by the drafter node (e.g., “You will be provided with a requirement for which a test case is to be drafted. You will also be provided with example test cases for this requirement and/or additional requirements to help you understand how to write the test case.”), instructions for performing the task (e.g., formatting of the test case, required fields in the test case, rules for drafting the test case, etc.), and/or other information related to the task. Input into these machine learning models 202 may also, or instead, include a certain number of requirements and/or corresponding test cases retrieved in step 502. Given this input, the drafter node may output a test case for the requirement.

The agent(s) 222 then perform a step 506 of generating a critique of the requirement based on the requirements paired with test cases and/or a set of standards. For example, step 416 may be performed by a “critic” node that is implemented using one or more LLMs, VLMs, MMLMs, and/or other types of machine learning models 202. Input into these machine learning models 202 may include one or more prompts 234 that specify a role of the critic node (e.g., “You critique systems engineering test cases”), a task to be performed by the critic node (e.g., “You will be given a test case and must provide helpful criticism”), criteria related to the task (e.g., standards for clarity, specificity, measurability, consistency, completeness, logical correctness, formatting, relevance to the system, etc.), and/or instructions for performing the task (e.g., “Make your feedback as clear as possible and explain your reasoning”). Input into these machine learning models 202 may also, or instead, include the drafted test case, related requirements paired with test cases, and/or standards. Given this input, the critic node may generate a critique that rates and/or assesses the degree to which the test case meets the specified criteria.

The agent(s) 222 perform a step 508 of revising the test case based on the critique. For example, step 508 may be performed by a “reviser” node that is implemented using one or more LLMs, VLMs, MMLMs, and/or other types of machine learning models 202. Input into these machine learning models 202 may include one or more prompts 234 that specify a task to be performed by the reviser node (e.g., “You revise system test cases based on the provided feedback”), a history of previous versions of the test case and corresponding feedback, instructions for performing the task (e.g., formatting of the test case according to a template, rules for revising the test case, etc.), and/or other information related to the task. Input into these machine learning models 202 may also, or instead, include the drafted test case and the critique. Given this input, the reviser node may generate revisions to the test case.

The agent(s) 222 receive additional user input 228 in the form of user feedback related to the revised test case. For example, the agent(s) 222 may output the revised test case generated in step 508 to the user in a chat interface and/or another type of user interface from which the initial input was received. The user may review the revised test case and provide feedback via the same user interface.

The agent(s) 222 may additionally repeat steps 506 and/or 508 one or more times to further revise the test case based on additional critiques and/or user feedback. For example, the agent(s) 222 may iteratively revise the test case until the user is satisfied with the decomposed requirements, the critique indicates that the requirements meet the specified criteria, and/or another condition is met.

FIG. 5B illustrates an example workflow 204 for generating systems engineering test code, according to at least one embodiment. As shown in FIG. 5B, the example workflow 204 begins with receiving user input 228 in the form of a test case identifier. For example, the test case identifier may be specified by a user via a chat interface and/or another type of user interface.

One or more agents 222 executing workflow 204 process user input 228 by performing a step 512 of retrieving the test case and/or related test cases paired with test code. For example, step 412 may be performed by a “researcher” node that matches the test case identifier to a test case and/or existing test code for the test case in data store 206. The researcher node may also use graph data 220 associated with the test case to identify one or more related test cases. The researcher node may also, or instead, identify the related test cases based on semantic similarity to the test case (e.g., as determined using cosine similarities between an embedding of the test case and embeddings of other test cases). The researcher node may additionally retrieve the test case and/or related test cases from data store 206 (e.g., using identifiers for the test cases in graph data 220 and/or search results of a semantic search associated with the test case). When the test case identifier cannot be matched to a corresponding test case in data store 206, the researcher node may search for similar test cases and corresponding test code based on semantic similarity to the test case identifier and/or other information in the provided user input 228.

Next, the agent(s) 222 perform a step 514 of drafting test code based on the test case(s) and test code. For example, step 514 may be performed by a “drafter” node that is implemented using one or more LLMs, VLMs, MMLMs, and/or other types of machine learning models 202. Input into these machine learning models 202 may include one or more prompts 234 that specify a task to be performed by the drafter node (e.g., “You write test code for Autonomous Vehicle features based on the provided USER PROMPT, test case descriptions and example test code”), instructions for performing the task (e.g., best practices for writing test code, use of test case and test code pairs in performing the task, criteria to be met by the test code, use of comments in the test code, syntax of the test code, function and class names in the test code, etc.), and/or other information related to the task. Input into these machine learning models 202 may also, or instead, include a certain number of test cases and/or corresponding test code retrieved in step 512. Given this input, the drafter node may output a script that includes test code for the test case.

The agent(s) 222 then perform a step 516 of generating lint results for the test code. For example, step 516 may be performed by a “lint” node that is implemented using static code analysis tools. The lint node may analyze the test code and generate corresponding lint results that identify programming errors, bugs, stylistic errors, and/or other types of issues.

The agent(s) 222 also perform a step 518 of generating a critique of the requirement based on the test case, lint results, and/or relevant documentation. For example, step 518 may be performed by a “critic” node that is implemented using one or more LLMs, VLMs, MMLMs, and/or other types of machine learning models 202. Input into these machine learning models 202 may include one or more prompts 234 that specify a role and/or task of the critic node (e.g., “You critique test code scripts based on a library for autonomous vehicle planning and control simulation,” “You will not tolerate anything but exceptionally well-written code scripts,” etc.), criteria related to the task (e.g., lint results from the lint node, standards for code quality, etc.), and/or instructions for performing the task (e.g., “Make your feedback as clear as possible and explain your reasoning,” “If there are lint issues, suggest how to resolve them,” etc.). Input into these machine learning models 202 may also, or instead, include the drafted test code and/or additional documentation that is retrieved via a search of documentation associated with the test case and/or test code (e.g., based on semantic similarity to the test case and/or test code, entities in the test case and/or test code, etc.). Given this input, the critic node may generate a critique that provides feedback related to the test code.

The agent(s) 222 perform a step 520 of revising the test code based on the critique. For example, step 520 may be performed by a “reviser” node that is implemented using one or more LLMs, VLMs, MMLMs, and/or other types of machine learning models 202. Input into these machine learning models 202 may include one or more prompts 234 that specify a task to be performed by the reviser node (e.g., “You revise test code based on provided feedback and lint results”), a history of previous versions of the test code and corresponding feedback, instructions for performing the task (e.g., best practices for writing test code, priorities for revising the test code, addressing the feedback and lint issues, etc.), and/or other information related to the task. Input into these machine learning models 202 may also, or instead, include the drafted test code, lint results, and critique. Given this input, the reviser node may generate revisions to the test code.

The agent(s) 222 receive additional user input 228 in the form of user feedback related to the revised test code. For example, the agent(s) 222 may output the revised test code generated in step 520 to the user in a chat interface and/or another type of user interface from which the initial input was received. The user may review the revised test code and provide feedback via the same user interface.

The agent(s) 222 may additionally repeat steps 516, 518, and/or 520 one or more times to further revise the test code based on additional lint results, critiques, and/or user feedback. For example, the agent(s) 222 may iteratively revise the test code until the user is satisfied with the test code, all lint issues have been resolved, the critique indicates that the test code meets all criteria, and/or another condition is met.

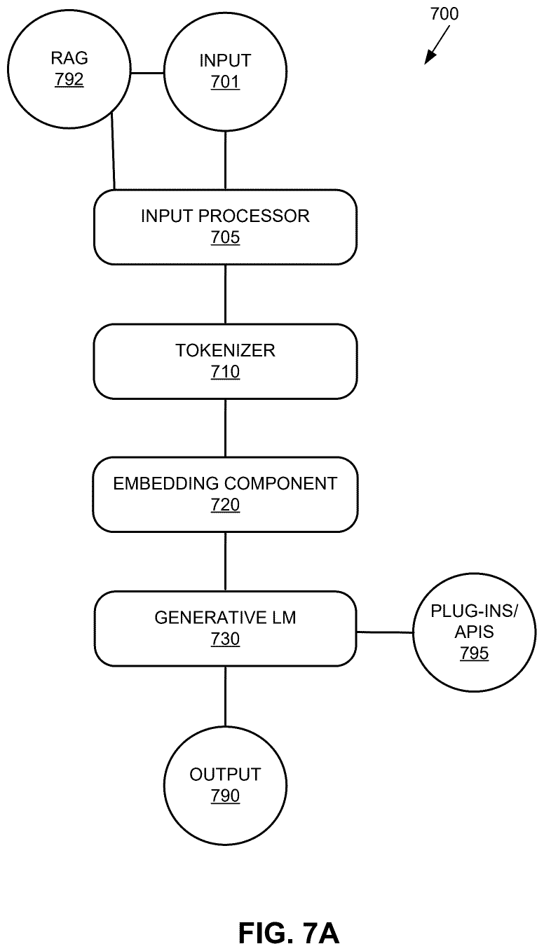

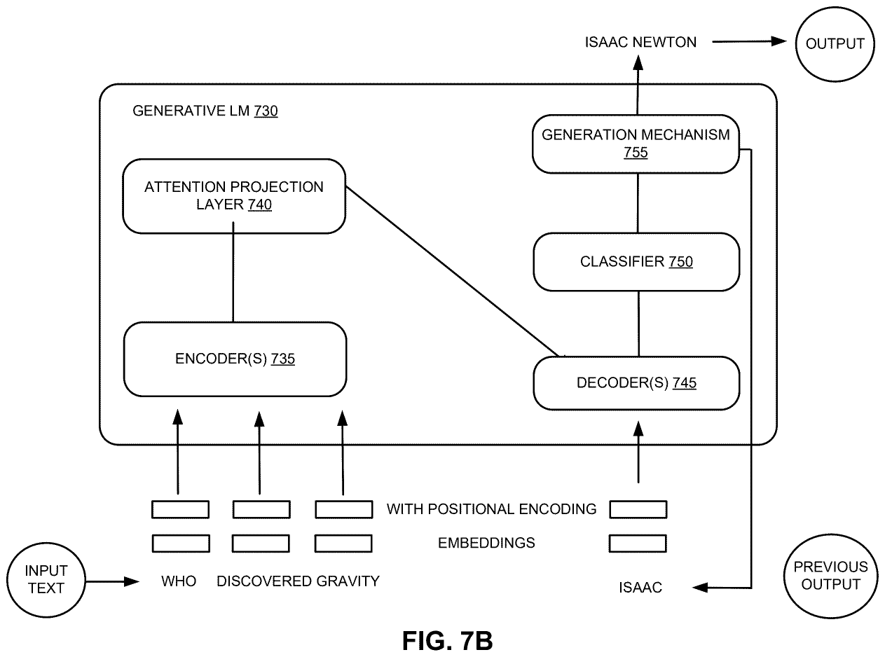

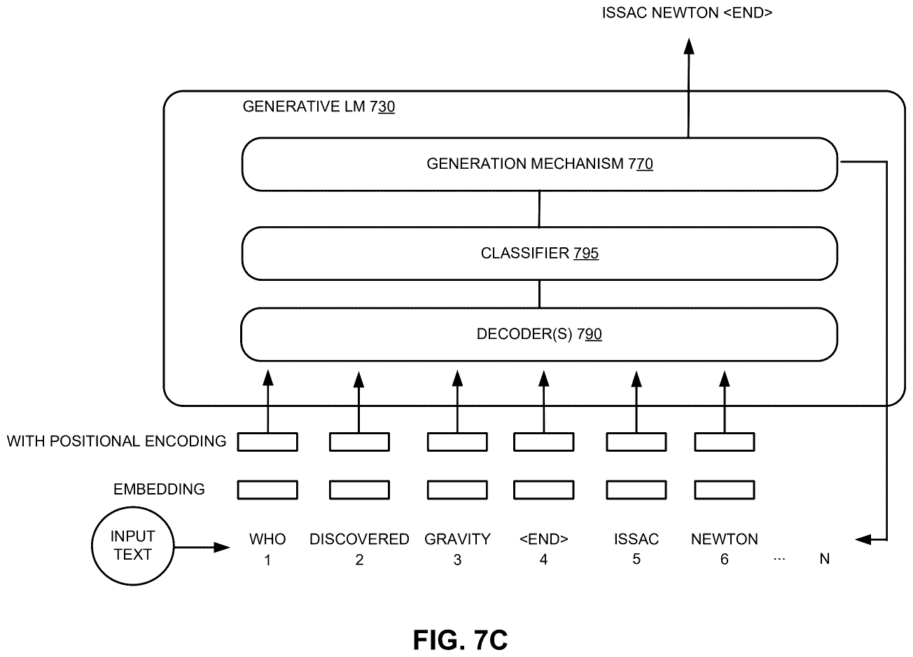

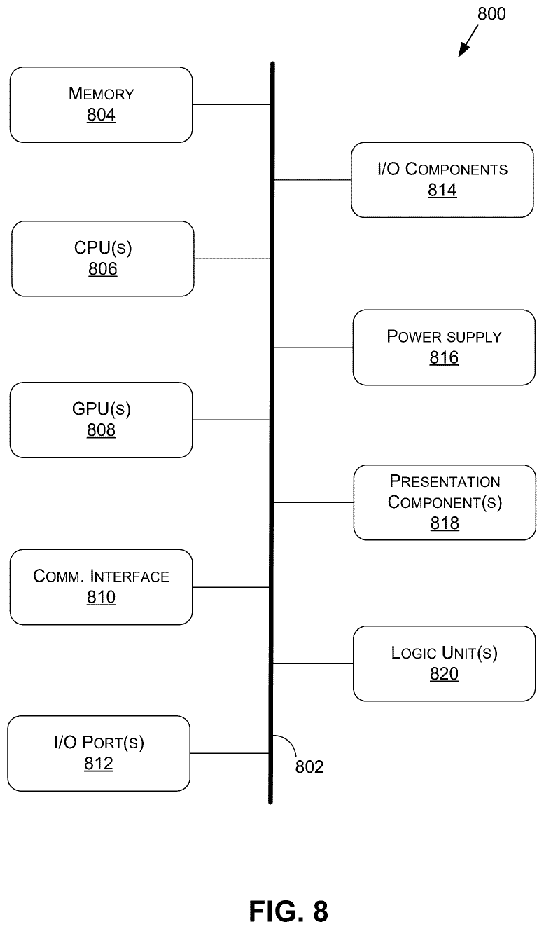

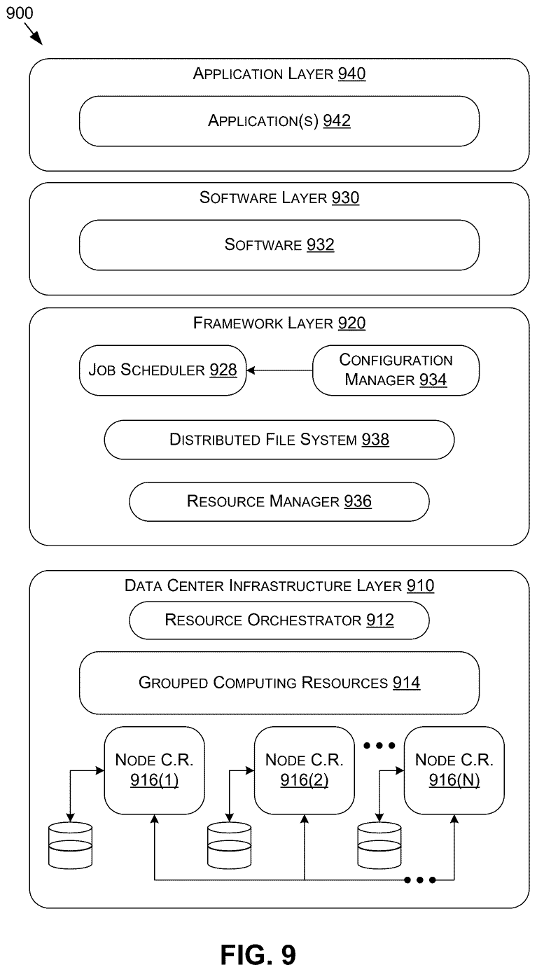

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 7A-7C), one or more computing devices or components thereof (e.g., as described in FIG. 8), and/or one or more data centers or components thereof (e.g., as described in FIG. 9).

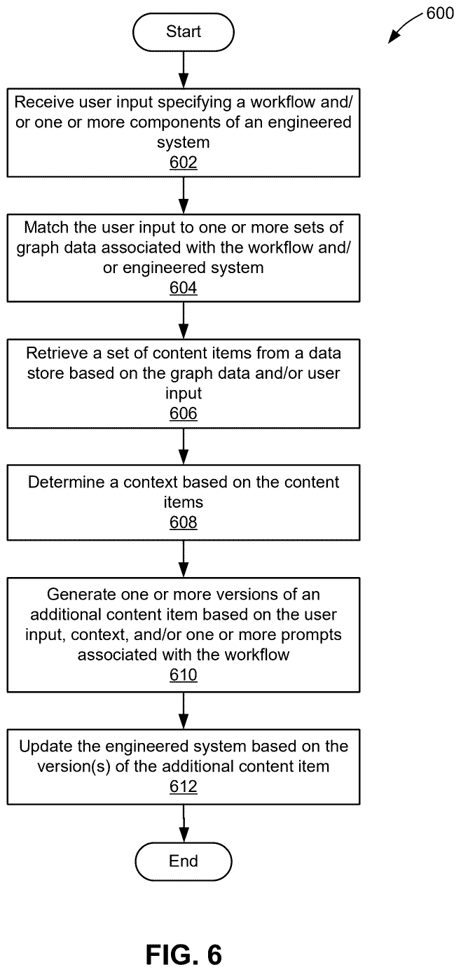

Now referring to FIG. 6, each block of method 600, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 600 is described, by way of example, with respect to the systems of FIGS. 1-2. However, this method may additionally or alternatively be executed by any one system, or any combination of systems, including, but not limited to, those described herein.

FIG. 6 is a flow diagram showing a method for executing a systems engineering workflow, according to at least one embodiment. As shown in FIG. 6, method 600 begins with operation 602, in which orchestration engine 122 receives user input specifying a workflow and/or one or more components of an engineered system. For example, the user input may include chat input, user-interface input, voice input, gestures, and/or other types of input that can be generated by a user. The user input may include commands, workflow names, clicks, and/or other input that can be used to identify the workflow. The user input may also, or instead, include identifiers, names, locations, and/or other representations of the engineered system, one or more requirements associated with the engineered system, one or more test cases associated with the requirement(s) and/or engineered system, test code associated with the test case(s) and/or engineered system, and/or other components of the engineered system. The user input may also, or instead, include a question to be answered using content related to the engineered system.

In operation 604, orchestration engine 122 matches the user input to one or more sets of graph data associated with the workflow and/or engineered system. For example, orchestration engine 122 may use named entities, identifiers, and/or other terms in the user input to retrieve the corresponding graph data. Orchestration engine 122 may also, or instead, perform a semantic search of the graph data using the user input and/or terms in the user input. The graph data may include nodes and edges representing the workflow, the architecture and/or layout of the engineered system, relationships and/or dependencies between components in the engineered system, and/or other types of data and/or relationships associated with the engineered system.

In operation 606, orchestration engine 122 and/or execution engine 124 retrieve a set of content items from a data store based on the graph data and/or user input. For example, orchestration engine 122 and/or execution engine 124 may use identifiers, names, descriptions, embeddings, and/or other representations of the graph data and/or user input to retrieve the content items from a vector database, relational database, key-value store, and/or another type of data store. The content items may include documentation, requirements, designs, test cases, test code, communications, error data, and/or other data related to the engineered system.

In operation 608, execution engine 124 determines a context based on the content items. For example, execution engine 124 may populate the context with the content items, a subset of information from the content items, a summary of the content items, embeddings and/or encodings of the content items, and/or another representation of the content items.

In operation 610, execution engine 124 generates one or more versions of an additional content item based on the user input, context, and/or one or more prompts associated with the workflow. For example, execution engine 124 may configure one or more agents and/or machine learning models to generate task outputs related to tasks performed within the workflow. The task outputs may include an initial version of the additional content item, lint results for code in the additional content item, one or more critiques of the additional content item, and/or one or more revisions to the additional content item.

In operation 612, orchestration engine 122 and/or execution engine 124 update the engineered system based on the version(s) of the additional content item. For example, orchestration engine 122 and/or execution engine 124 may determine a final version of the additional content item as a revision that resolves all lint issues, meets criteria associated with the critique(s), and/or is deemed satisfactory by the user. Orchestration engine 122 and/or execution engine 124 may additionally store the final version of the additional content item as a new requirement, requirement decomposition, test case, test code, and/or another component of the engineered system in the data store. Orchestration engine 122 and/or execution engine 124 may also, or instead, output the final version of the additional content item as an answer to a question from the user. Orchestration engine 122 and/or execution engine 124 may also, or instead, incorporate the final version of the additional content item into a document, test, and/or process related to the engineered system.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a multi-modal LM, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant—such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features—such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text, task output 224 related to a systems engineering workflow, and/or other types of data.

As described herein, in some embodiments, the generative LM 730 may be configured to access or use—or capable of accessing or using-plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 7A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. For example, the CPU(s) 806 may be configured to execute orchestration engine 122 and/or execution engine 124 of FIG. 1. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. For example, the GPU(s) 808 may be configured to execute orchestration engine 122 and/or execution engine 124 of FIG. 1. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments. In some embodiments, application(s) 942 include orchestration engine 122 and/or execution engine 124 of FIG. 1.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floting point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, systems for performing generative AI operations, systems implementing one or more language models—such as one or more large language models (LLMs), cloud computing and/or any other suitable applications.

### Example Autonomous Vehicle

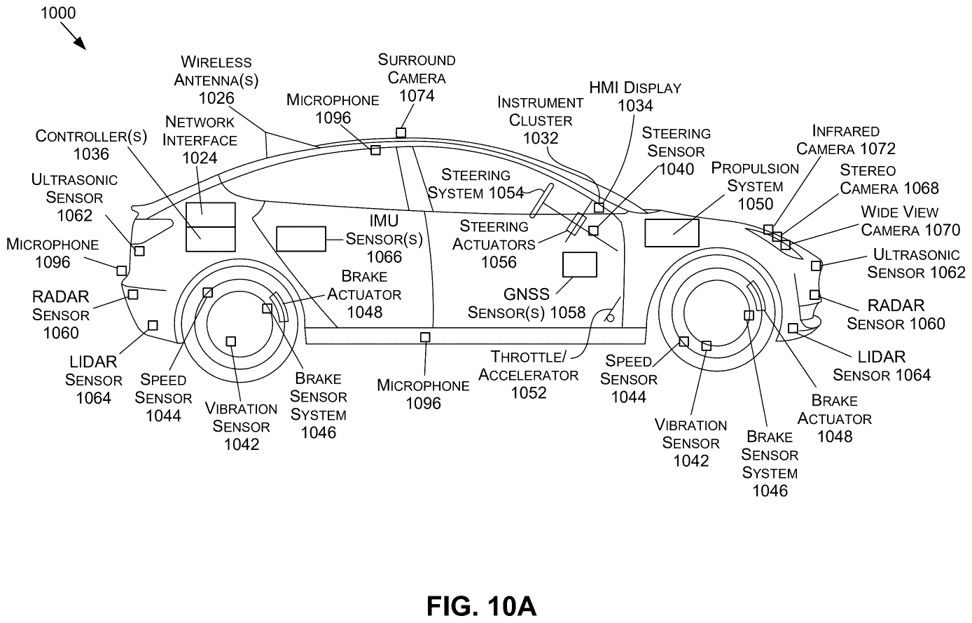

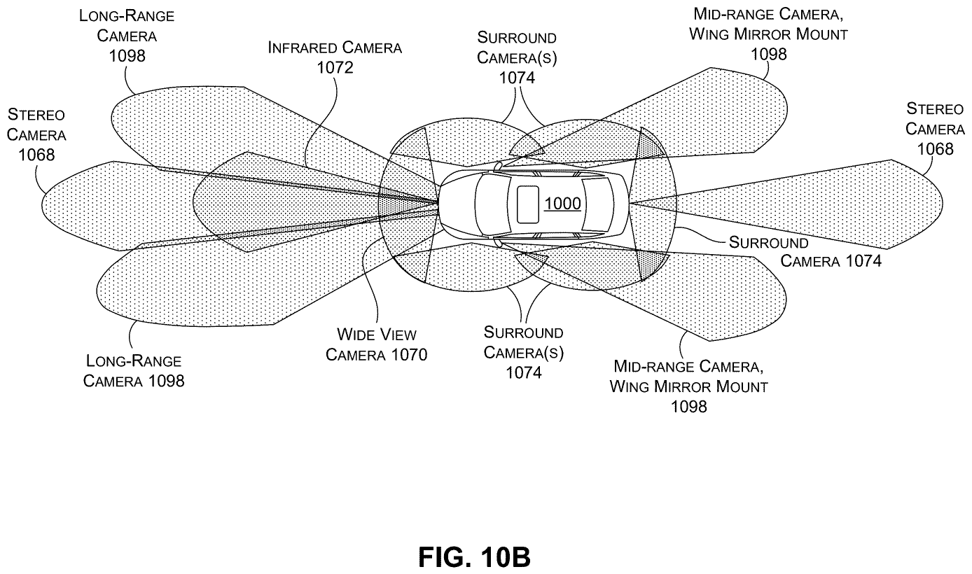

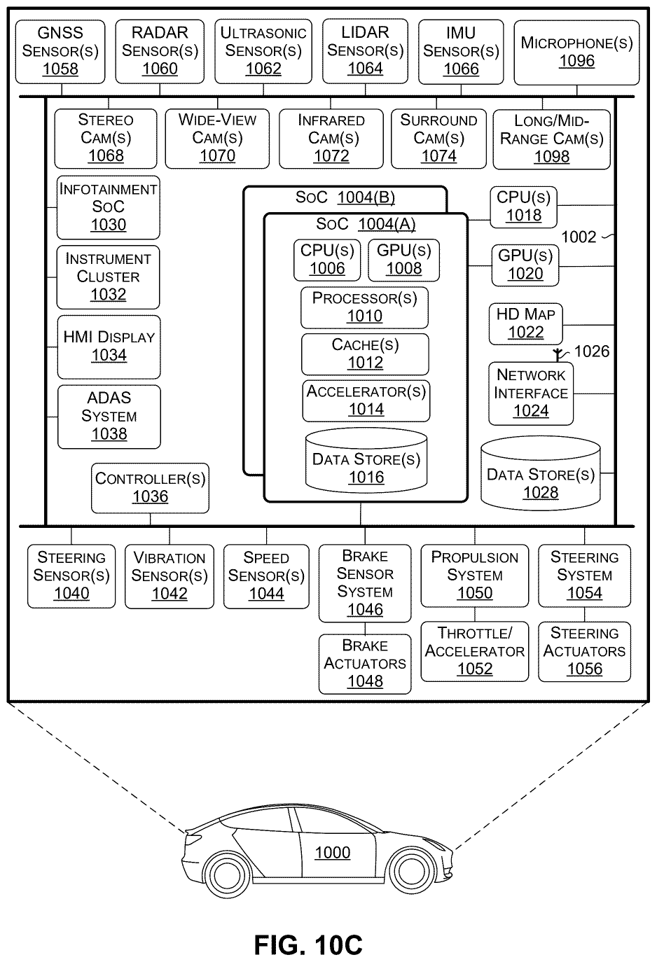

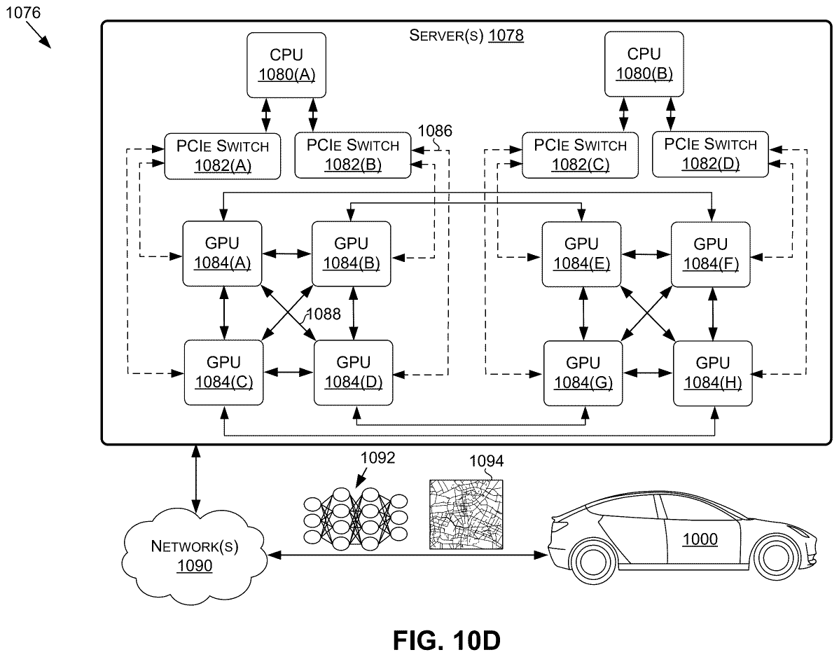

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), an autonomous robot, a humanoid robot, and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously. In some embodiments, image data from one or more cameras may be used to generate memories that enable long-term perception for the vehicle 1000, as discussed herein.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data. In some embodiments, the data store(s) 1028 include a vector database and/or another type of data store 206 that can be used to store representations of documentation 208, requirements 210, designs 212, test cases 214, test code 216, communications 218, error data 230, and/or other data associated with the vehicle 1000.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multi-modal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

In some examples, the server(s) 1078 may configure and/or execute agentic workflows for generating, managing, and/or testing various components of the vehicle 1000. The server(s) 1078 may also, or instead, store and/or transmit documentation 208, requirements 210, designs 212, test cases 214, test code 216, communications 218, error data 230, and/or other data associated with the vehicle 1000.

In sum, the disclosed techniques provide a set of customized agentic workflows to streamline various systems engineering tasks. These agentic workflows have access to data from a variety of data sources, including (but not limited to) requirements, models, engineering documents, team communications, databases, knowledge graphs, bug reports, test cases, and/or test results. These agentic workflows may be used to perform tasks such as (but not limited to) question answering; requirement authoring, revision, and/or decomposition; and/or generation and/or refinement of test cases and/or test code.

Each agentic workflow includes one or more large language model (LLMs), vision language models (VLMs), multimodal language models, and/or other types of machine learning models that are capable of generating predictive output based on inputted text, images, audio data, video data, and/or other types of data. The machine learning model(s) may implement agents that act as mappers, researchers, drafters, critics, revisers, linters, and/or other roles in systems engineering processes. Each agent performs a corresponding set of one or more tasks based on a system prompt that describes a corresponding role, a user prompt that includes information and/or instructions that can be used to perform the task(s), and/or one or more example inputs and/or outputs associated with the task(s). Output generated by the agent may be provided to another agent in the same agentic workflow and/or a user, and a final output of the agentic workflow may be generated via iterative execution of some or all agents in the agentic workflow based on critiques of the output by one or more agents and/or feedback from the user.

One technical advantage of the disclosed techniques relative to prior approaches is the ability to efficiently access, search, retrieve, and/or define information that is relevant to a given systems engineering task. Consequently, the disclosed techniques reduce latency and/or resource overhead over conventional approaches that involve manually locating and retrieving information that is relevant to a systems engineering task and/or resolving acronyms, named entities, terms, jargon, and/or other domain-specific vocabulary related to the systems engineering task. Another technical advantage of the disclosed techniques is the ability to adapt and/or customize the agents and/or stages within a given agentic workflow to the dependencies, data formats, and/or structure of a corresponding systems engineering task. The disclosed techniques can thus improve the quality of output generated by the agentic workflows over conventional approaches that use LLMs with RAG to generate responses to user prompts.
1. In some embodiments, a method comprises matching a user input to one or more sets of graph data associated with an engineered system; determining a context based at least on one or more content items associated with the one or more sets of graph data; generating, via execution of a first machine learning model, an initial version of an additional content item based at least on the context; generating, via execution of a second machine learning model, one or more revisions to the additional content item based at least on one or more critiques associated with the additional content item; and causing the engineered system to be updated based at least on the one or more revisions to the additional content item.
2. The method of clause 1, wherein the matching the user input to the one or more sets of graph data comprises generating an embedding of at least a portion of the user input; and matching the embedding to a set of nodes included in the one or more sets of graph data.
3. The method of any of clauses 1-2, wherein the determining the context comprises retrieving the one or more content items from one or more data sources based at least on the set of nodes.
4. The method of any of clauses 1-3, wherein the generating the one or more revisions to the additional content item comprises generating, via a third machine learning model, a first critique that is (i) included in the one or more critiques and (ii) associated with the initial version; and generating, via execution of the second machine learning model, a first revision included in the one or more revisions based at least on the first critique and the initial version.
5. The method of any of clauses 1-4, wherein the generating the one or more revisions to the additional content item further comprises receiving user feedback comprising a second critique that is (i) included in the one or more critiques and (ii) associated with the first revision; and generating, via execution of the second machine learning model, a second revision included in the one or more revisions based at least on the user feedback and the first revision.
6. The method of any of clauses 1-5, wherein the generating the one or more revisions to the additional content item further comprises generating an additional context based at least on the first revision and the first critique; and inputting the additional context and an additional prompt to revise the additional content item based at least on the additional context into the second machine learning model.
7. The method of any of clauses 1-6, wherein the user input comprises at least one of a workflow associated with the additional content item, the engineered system, or one or more components of the engineered system.
8. The method of any of clauses 1-7, wherein the additional content item comprises at least one of a requirement, a requirement decomposition, a revised requirement, a test case, test code, or an answer to a question.
9. The method of any of clauses 1-8, wherein the one or more sets of graph data comprise a set of components included in the engineered system and a set of dependencies associated with the set of components.
10. The method of any of clauses 1-9, wherein the one or more sets of graph data comprise a sequence of steps within a workflow associated with the additional content item.
11. In some embodiments, at least one processor comprises processing circuitry to cause performance of operations comprises matching a user input to one or more sets of graph data associated with an engineered system; determining a context based at least on one or more content items associated with the one or more sets of graph data; generating, via execution of one or more machine learning models, an additional content item based at least on the context; and causing the engineered system to be updated based at least on the additional content item.
12. The at least one processor of clause 11, wherein the generating the additional content item comprises generating, via execution of a first machine learning model included in the one or more machine learning models, one or more critiques associated with the additional content item; and generating, via execution of a second machine learning model included in the one or more machine learning models, one or more revisions to the additional content item based at least on the one or more critiques.
13. The at least one processor of any of clauses 11-12, wherein the causing the engineered system to be updated comprises generating a final version of the additional content item based at least on the one or more revisions to the additional content item; and storing the final version of the additional content item in a knowledge base associated with the engineered system.
14. The at least one processor of any of clauses 11-13, wherein the generating the additional content item further comprises generating, via execution of the second machine learning model, one or more additional revisions to the additional content item based at least on user feedback associated with the additional content item.
15. The at least one processor of any of clauses 11-14, wherein the first machine learning model generates the one or more critiques based at least on at least one of the one or more content items or a set of standards associated with the additional content item.
16. The at least one processor of any of clauses 11-15, wherein the one or more machine learning models comprise at least one of a large language model, a vision language model, a multi-modal language model, a named entity recognition technique, or a natural language processing technique.
17. The at least one processor of any of clauses 11-16, wherein the user input comprises at least one of a question, a requirement identifier, a requirement, the engineered system, a use case definition, a test case identifier, or a test case.
18. The at least one processor of any of clauses 11-17, wherein the at least one processor is comprised in at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.
19. In some embodiments, a system comprises one or more processing units to generate a response to a user input associated with an engineered system, the response being generated based at least on a context that includes content associated with the user input, the content being determined based at least on graph data representing a set of components associated with the engineered system.
20. The system of clause 19, wherein the system is comprised in at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
matching a user input to one or more sets of graph data associated with an engineered system;
determining a context based at least on one or more content items associated with the one or more sets of graph data;
generating, via execution of a first machine learning model, an initial version of an additional content item based at least on the context;
generating, via execution of a second machine learning model, one or more revisions to the additional content item based at least on one or more critiques associated with the additional content item; and
causing the engineered system to be updated based at least on the one or more revisions to the additional content item.

2. The method of claim 1, wherein the matching the user input to the one or more sets of graph data comprises:
generating an embedding of at least a portion of the user input; and
matching the embedding to a set of nodes included in the one or more sets of graph data.

3. The method of claim 2, wherein the determining the context comprises retrieving the one or more content items from one or more data sources based at least on the set of nodes.

4. The method of claim 1, wherein the generating the one or more revisions to the additional content item comprises:
generating, via a third machine learning model, a first critique that is (i) included in the one or more critiques and (ii) associated with the initial version; and
generating, via execution of the second machine learning model, a first revision included in the one or more revisions based at least on the first critique and the initial version.

5. The method of claim 4, wherein the generating the one or more revisions to the additional content item further comprises:
receiving user feedback comprising a second critique that is (i) included in the one or more critiques and (ii) associated with the first revision; and
generating, via execution of the second machine learning model, a second revision included in the one or more revisions based at least on the user feedback and the first revision.

6. The method of claim 4, wherein the generating the one or more revisions to the additional content item further comprises:
generating an additional context based at least on the first revision and the first critique; and
inputting the additional context and an additional prompt to revise the additional content item based at least on the additional context into the second machine learning model.

7. The method of claim 1, wherein the user input comprises at least one of a workflow associated with the additional content item, the engineered system, or one or more components of the engineered system.

8. The method of claim 1, wherein the additional content item comprises at least one of a requirement, a requirement decomposition, a revised requirement, a test case, test code, or an answer to a question.

9. The method of claim 1, wherein the one or more sets of graph data comprise a set of components included in the engineered system and a set of dependencies associated with the set of components.

10. The method of claim 1, wherein the one or more sets of graph data comprise a sequence of steps within a workflow associated with the additional content item.

11. At least one processor comprising:
processing circuitry to cause performance of operations comprising:
matching a user input to one or more sets of graph data associated with an engineered system;
determining a context based at least on one or more content items associated with the one or more sets of graph data;
generating, via execution of one or more machine learning models, an additional content item based at least on the context; and
causing the engineered system to be updated based at least on the additional content item.

12. The at least one processor of claim 11, wherein the generating the additional content item comprises:
generating, via execution of a first machine learning model included in the one or more machine learning models, one or more critiques associated with the additional content item; and
generating, via execution of a second machine learning model included in the one or more machine learning models, one or more revisions to the additional content item based at least on the one or more critiques.

13. The at least one processor of claim 12, wherein the causing the engineered system to be updated comprises:
generating a final version of the additional content item based at least on the one or more revisions to the additional content item; and
storing the final version of the additional content item in a knowledge base associated with the engineered system.

14. The at least one processor of claim 12, wherein the generating the additional content item further comprises generating, via execution of the second machine learning model, one or more additional revisions to the additional content item based at least on user feedback associated with the additional content item.

15. The at least one processor of claim 12, wherein the first machine learning model generates the one or more critiques based at least on at least one of the one or more content items or a set of standards associated with the additional content item.

16. The at least one processor of claim 11, wherein the one or more machine learning models comprise at least one of a large language model, a vision language model, a multi-modal language model, a named entity recognition technique, or a natural language processing technique.

17. The at least one processor of claim 11, wherein the user input comprises at least one of a question, a requirement identifier, a requirement, the engineered system, a use case definition, a test case identifier, or a test case.

18. The at least one processor of claim 11, wherein the at least one processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

19. A system comprising:
one or more processing units to generate a response to a user input associated with an engineered system, the response being generated based at least on a context that includes content associated with the user input, the content being determined based at least on graph data representing a set of components associated with the engineered system.

20. The system of claim 19, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
